(19) United States
(12) Patent Application Publication
(10) Pub. No.: US 2016/0049069 A1
(43) Pub. Date: Feb. 18, 2016

(54) Anti-Theft Wireless Protection System

(71) Applicant: Paulo BR Oliveira, West Palm Beach, FL (US)

(72) Inventor: Paulo BR Oliveira, West Palm Beach, FL (US)

(21) Appl. No.: 14/459,327

(22) Filed: Aug. 14, 2014

(51) Int. Cl. G08B 25/10; G08B 13/22; G08B 21/24

(52) U.S. Cl. CPC G08B 25/10; G08B 21/24; G08B 13/22

(57) ABSTRACT

The present invention is a system and method for protection against theft of personal items or accidentally forgetting them in public places. The idea is for the owner to carry a main Master device worn on the belt, the wrist, or any other convenient place. This Master device is in contact communication with smaller mobile Portable devices attached to all the personal items that need protection. When a Portable device is too far from the Master device, it is assumed to have been stolen, forgotten or left behind. Both devices have the capability of sounding an alarm. The wireless distance is adjustable and programmed via the user's menu on the Master device based on the individual need for each Portable device.

### BACKGROUND OF THE INVENTION

In a more technologically-advanced and savvy world, it is commonplace for individuals to carry multiple digital and electronic items such as a smartphone, a tablet or iPad and a laptop computer, often with a briefcase also having technologically advanced gadgets and gizmos.

As the number of the aforementioned devices proliferates, there is additional opportunity for the loss, misplacement and theft of such items, often initially caused by the temporary or long-term departure by the owner of the items from the scene. In addition, when thieves or mal-intended individuals notice the departure of the owner, there is a higher risk of them closing in on the scene and then misappropriating and departing with the items in question.

News channels have reported a dramatic increase in the casing and robbery by such individuals of electronic items. See e.g. “A national crime trend called “Apple picking” targets smart phones and it has reached South Florida. Miami Beach Police said the Apple iPhone thefts have spiked crime statistics.” MIAMI BEACH (CBS4), at:

http://miami.cbslocal.com/2013/08/19/apple-picking-blowing-up-on-south-beach/

There is thus a need for the user to have a “friend” that could help that and other users like him or her “police” their items and remind them when needed, and a search of available technology brought up only partial and unsatisfactory solutions to the problem. The idea then is to create a device that could eliminate these problems simultaneously for multiple items, wherein a smart master device keeps constantly monitoring portable secondary devices attached to all the items to be protected. When those portable units are in certain conditions and further away from the master than an allowed preset distance, an alarm will sound calling for the user's attention.

### RELATED ART

U.S. Pat. No. 4,593,273 A, issued to Narcisse on Jun. 3, 1986, for an “Out-of-range personnel monitor and alarm” discloses an out-of-range monitor and alarm system that may be used by a convalescent home or the like to alert an attendant in the home that a supervised person has walked beyond a predetermined prescribed distance. The system includes a base unit and a receiver which communicate at a signal in a mobile unit carried by the supervised person at a given frequency. The receiver monitors the threshold using circuitry and the distance is monitored by the signal strength. An alarm is consequently sounded when the signal strength diminishes beyond a certain value.

U.S. Pat. No. 5,652,569 A, issued to Gerstenberger et al on Jul. 29, 1997 discloses a child alarm device consisting of a transmitter held or carried by a guardian and a receiver mounted inside a backpack worn by a child, which automatically triggers an audible alarm where the child wanders out of range. Another audible alarm for the child may be triggered manually by the guardian, and a third alarm may be triggered by the child itself by disconnecting a chest strap, which acts as an optional “Panic Button”. The backpack is tamper-proof, and the whole system works on a single channel code.

U.S. Pat. No. 5,640,144 A, issued to Russo et al on Jun. 17, 1997 discloses an RF/ultrasonic separation distance alarm system for preventing loss or theft of one or more articles with an ultrasonic transmitter incorporated in the article(s) to be protected, which transmits an ultrasonic signal to a receiver on a monitoring unit. An alarm is triggered, for example when the distance between the receiver and transmitter exceeds a predetermined value. The monitoring unit periodically polls protected articles with a coded RF signal that is decoded and identified by the protecting device of each concerned article, and an ultrasonic coded signal is emitted in response. This ultrasonic coded signal is received in turn by the monitoring unit which triggers an alarm when predetermined conditions are met. Two receiving channels may be arranged in space diverse relationship for better receiving the ultrasonic signal, and the distance between the monitoring unit and the article to be protected may be adjusted. The system, whose patent already expired in 2005, and it is already public covers personal items which are lost or stolen, and has some similarities to the idea of this invention but not the same. The idea of the present invention has many enhanced security and practical features.

U.S. Pat. No. 7,129,842 B2, issued to Hope on Oct. 31, 2006 discloses a MEMS sensor unit for wireless security applications that provides the unit an extended battery life for, to achieve both capability of an immediate MEMS motion detection and “out of range” detection when the unit is moved beyond range of a security system receiver, without the unit having an unacceptable reduction in battery life for the MEMS sensor unit. This is an enhanced version of the prior reference to Russo. It also bears some is similarities to the present invention, without the many unique features.

There are also some after-market products available but none of great quality and effectiveness:

A Keychain Anti-Lost Baby Pet Mobile Cell phone Wallet Theft Safety Security Wireless Alarm Reminder listed on Amazon at http://www.amazon.com/BW-Keychain-Anti-Lost-Electronic-Reminder/dp/B0098OFKHC is a cheap, mass-produced product with very bad review because it lacks the accuracy and dependability, not to mention the inconvenience of not having a recharging mechanism.

Similarly. SainSpeed TK102 Rechargeable Mini Real-Time Anti-theft GSM/GPS/GPRS Tracker Device w Micro SD Memory Card Capability for Global Sim Card, listed on Amazon at http://www.amazon.com/SainSpeed-Rechargeable-Real-Time-Anti-theft-Capabilty/mdp/B00CXMRGN2 is a tracking system useful for tracking large items which requires monthly phone service and is too large and impossible to attach to small personal items to be protected, hence not much better reviews than the device listed prior.

### SUMMARY OF THE INVENTION

The present invention helps the user in protection of his or her personal mobile electronic technology items, such as a watch, mobile phone, tablet device, laptop, briefcase, etc. by constantly wirelessly monitoring their presence in proximity to and relative to the user within an allowed threshold distance. The system comprises three components: a master unit, more than one portable wireless communication units each corresponding to a device to be protected, the master unit and each portable unit powered by a rechargeable battery which itself is charged by equipped a wireless charger using a contactless system of inductive electromagnetic waves. The master unit itself comprises an LCD screen which supports an user interface and a menu having several options and settings to manage the operation of the system.

The master unit and the portable units each has the master unit and the portable units are each equipped with a wireless transceiver, and the wireless transceiver of the master unit constantly communicates with and polls each portable device's wireless transceiver wirelessly by means of wireless communication signals in order to measure the distance between the two devices. When a protected item and its attached portable device are too great a distance away from the master, an alarm may sound either at the master device or at the portables. The menu settings may be set to sound the alarm also if there is a rapid movement of a portable and attached device so that if an item is snatched or moved, the alarm sounds, and this can also be made conditional on the user/owner being away and at a greater threshold to the item being monitored.

The Master device can be made to be as a keychain/fob etc. watch, briefcase etc., to be worn by the user. Similarly, the portables can be made to fit a briefcase, a laptop, wristwatch, mobile phone or tablet. They may be either built into, and thus become part of the items being protected, or else be attached securely and snugly to them.

The charger construction may be a flatbed charger for charging the rechargeable battery on each master unit and portable units to be charged through radio wave induction. In the alternative, each charger may be made cylindrical, and mate with a cylindrical hole on the unit being charged through a male female type snug connection, for better delivery of the electromagnetic field with volume to charge the master or portable units, still using wireless contact and radio wave induction.

### BRIEF DESCRIPTION OF THE DRAWINGS

FIG. 1 is the overall TPoli system components, Master, Portable and Charger showing a user wearing the Master with some personal items with Portable units and Chargers.

FIG. 2 is a detailed functional block diagram of the Master device

FIG. 3 is a detailed functional block diagram of a Portable in shape of a mobile phone sleeve

FIG. 4 is a detailed functional block diagram of a Portable for a wrist watch

FIG. 5 is a detailed functional block diagram of a Portable for a briefcase

FIG. 6 is a detailed functional block diagram of a Portable for a laptop

FIG. 7 is a detailed functional block diagram of the Charger

FIG. 8 is a detailed functional block diagram of TPoli Charger using Cylinders

### DETAILED DESCRIPTION

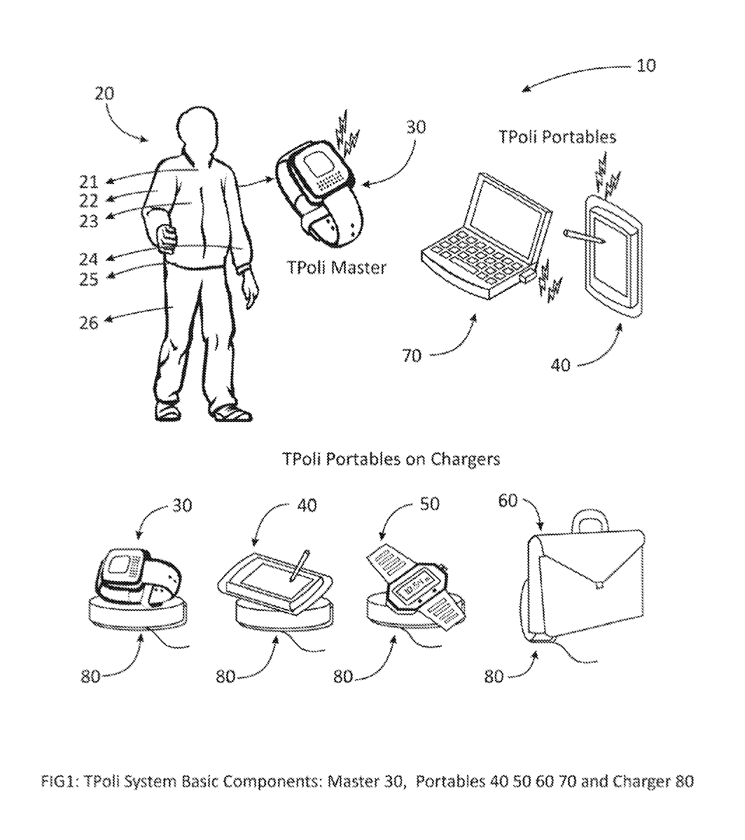

The present invention facilitates the protection of personal mobile electronic technology items, such as a watch, mobile phone, tablet device, laptop, briefcase. etc. by constantly wirelessly monitoring their presence in proximity to and relative to the user within a certain allowed threshold distance. As shown in FIG. 1, the overall TPoli system 10 is composed of three main components; Master, Portables and Charger. A person user 20 is depicted wearing the Master (TPoli Master) 30, with various protected personal items with Portables 40, 50, 60, and 70 which are connected attached to them, and Chargers 80 in action for charging all devices. The wearable Master device 30 has the main wireless link to all Portable devices. It is worn on neck 21, chest 23, arm 22, rest 24, leg 26, belt 25 or any convenient place on the body. The Master Device 30 consists of the Master controller 32 and the Master band, which in this case enable the users 20 wears it on his rest 24. The Master Controller 32 is equipped with a wireless transceiver 33 which constantly checks how far the Portable devices 40 are from it. If the distance is greater than the allowed value, the devices will sound an alarm.

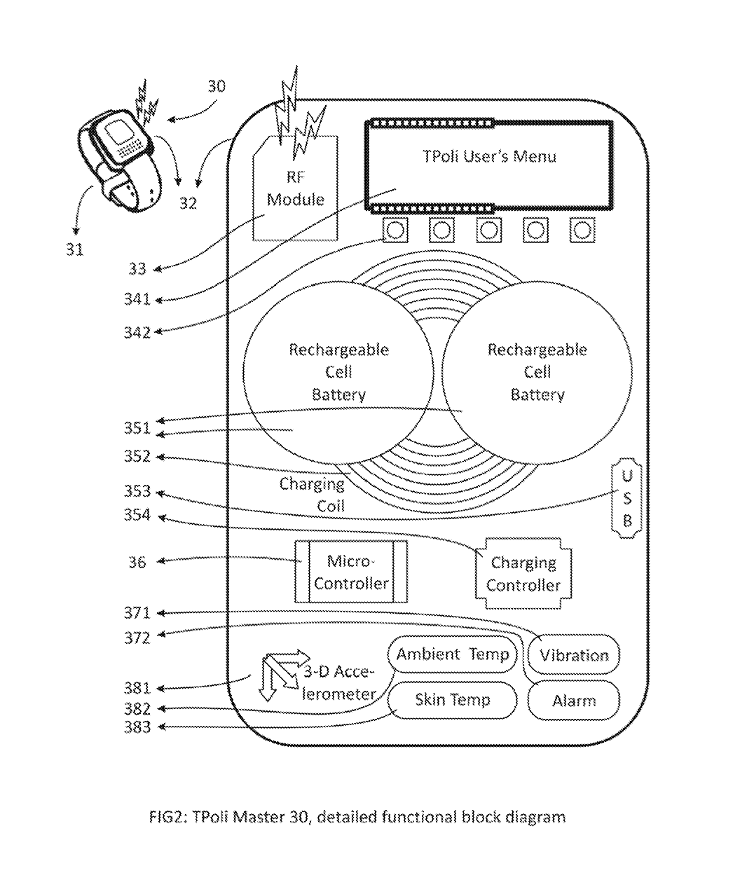

FIG. 2 illustrates the detailed functional block diagram of the Master device 30. The charging coil 352, energized by the Charger 80, charges the batteries 351. The Master device 30 is worn by the user 20 in a secured location, so that it is less likely to be removed or forgotten behind. It can comprise a stand-alone unit, in a form of a key chain fob or belt-clip attachment, or instead may be built-in or embedded in other device such as any of devices listed as Portables 40, 50, 60, and 70. The Master 30 operates on a rechargeable battery 351 which is charged by contactless inductive electromagnetic waves, simply by placing it on the Charger bed 81. The Master is equipped with an LCD screen 341 and programming buttons 342 for user interface, which implements a menu giving the user various options, choices and settings to manage the operation of the entire system:
i. The alarm 372, 472, 572, 672, 772, and 872 sounds on the Master 30, on any of the Portables 40, 50, 60, 70, the Charger 80, or both the Master and the portable.
ii. The user may enter a custom value for the allowed/safe distance between the Master and each Portable device.
iii. The alarm could be set as an audible 372, visual, or vibrate mode 371.
iv. The Master may manually ‘pull’ all the Portables individually or all at once.
v. The portables, in turn, may be set to trigger the alarm, based on distance from Master, transition from being stationary to moving (sensed by accelerometer 381), transition from moving to violent movement 381, excessive temperature 382, low battery 351, or any combination of the above. The movement is detected from the 3-d accelerometer sensor 381.

The Portable Device (TPoli Portable) 40, 50, 60, or 70 is equipped with a wireless transceiver 43, 53, 63, or 73 that is constantly pulled by the Master 30 to measure the distance between the two devices. A Portable device may be attached to each personal item that needs protection. It must securely either fit or comprise part of the personal item to avoid accidental detachment. Portable Devices come in different styles and shapes to fit an intended personal item.

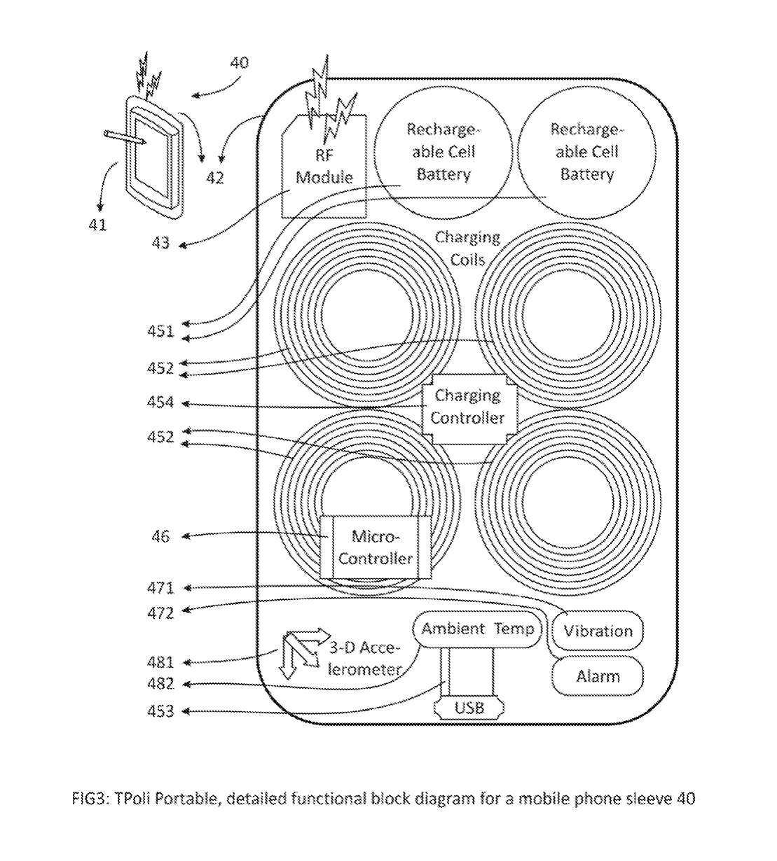

FIG. 3 is a detailed functional block diagram of the Portable 40 in the form of a mobile phone or smart phone fitted sleeve. For a mobile phone 40, the Portable is actually a fitted protective sleeve 42, which the phone 41 slips into. At the bottom of the sleeve, it has a USB jack which mates with the USB socket on the smart or mobile phone when inserted into the sleeve. This way, the sleeve charges the phone while the sleeve is in turn itself being charged by the contactless Charger. This sleeve 42 contains the RF circuitry 43 which communicates with the Master 30, the contactless charging circuitry 452, 454, and an embedded plug 453 which charges the phone 41 as well, while the sleeve is on the Charger bed 80.

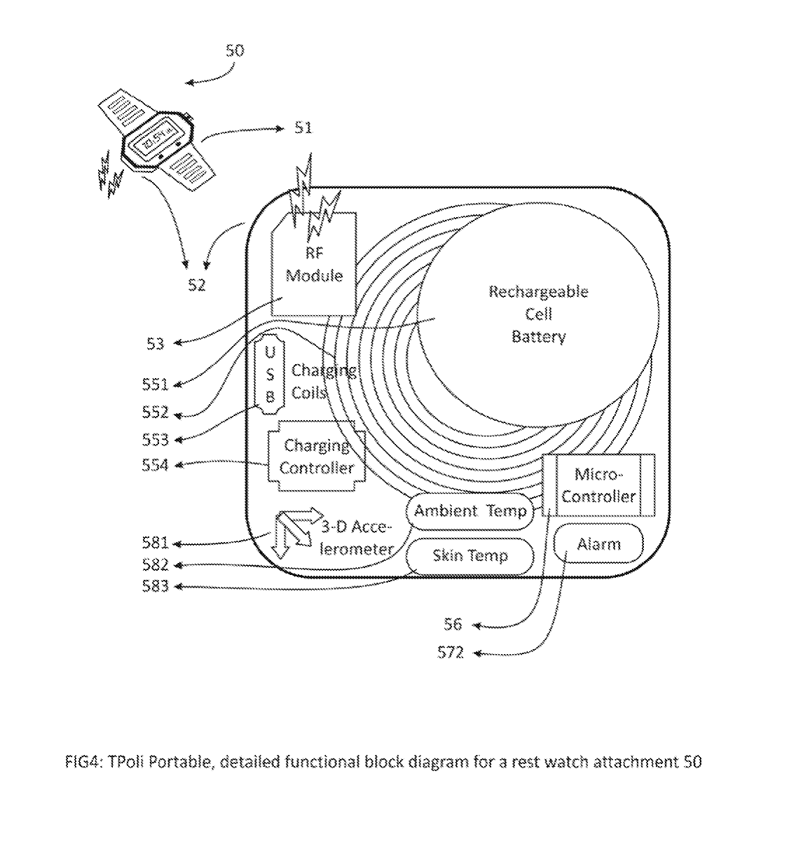

FIG. 4 is a detailed functional block diagram of the Portable as a wrist watch. For watch 50, the Portable device may be a link of the watch band or an attachment to the band 52. This Portable device is a thin attachment which may be placed under the watch or made as integral part of the watch band. It has a micro USB socket for quick charging and a charging coil for contactless charging at the night time. It has an accelerometer for detecting the movement status, and an audible alarm. It has temperature sensors to sense both the skin and the ambient temperatures.

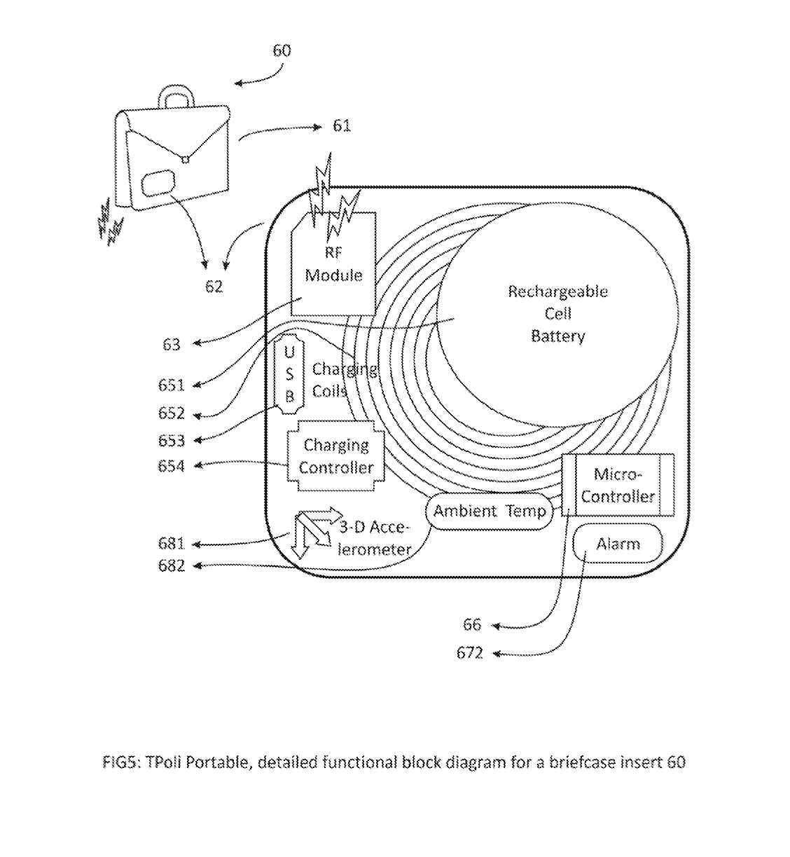

FIG. 5 shows a detailed functional block diagram of the Portable for a briefcase. This Portable device is a an insert that could be placed inside a wallet, a briefcase, a suitcase, a purse, a baby stroller, or nay hand held or personal items that need to be protected. For a briefcase 60, the Portable is dongle 62 hidden inside the briefcase 61, having a micro USB socket for quick charging and a charging coil for contactless charging at the night time. It has an accelerometer for detecting the movement status, and an audible alarm. It has a temperature sensor to sense the ambient temperatures. It may also have a GPS sensor for tracking purposes.

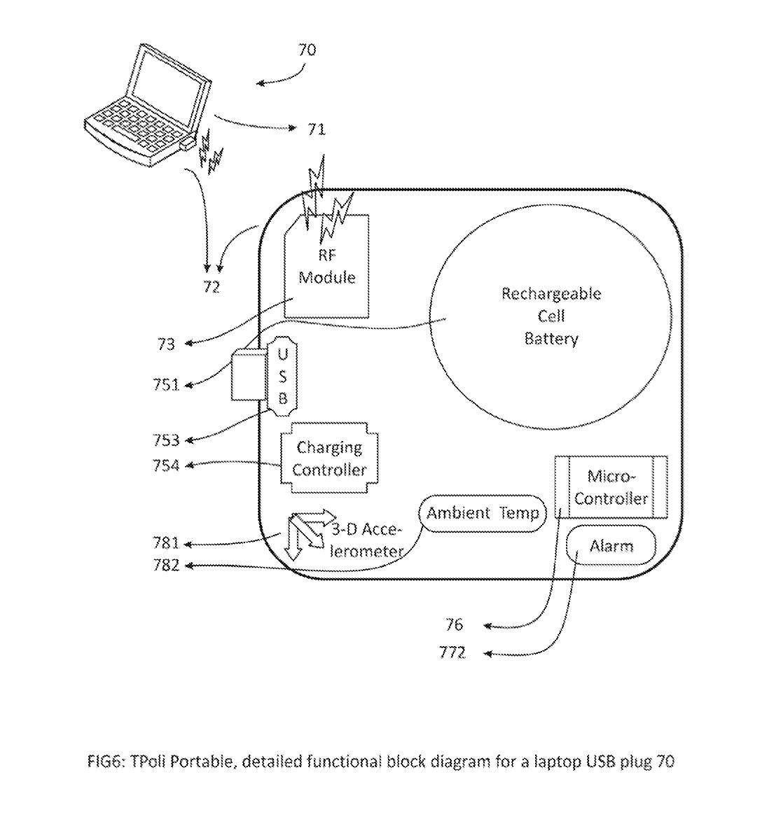

FIG. 6 is a detailed functional block diagram of the Portable for a laptop. For a laptop 70, the portable device is in the shape of a USB mini plug 72 which plugs directly and kept permanently plugged into the USB port of the laptop 71. It is continuously recharging from the laptop while the laptop is turned on. It has an accelerometer for detecting the movement status, and an audible alarm. It has a temperature sensor to sense the ambient temperatures. When the computer is turned on, the Portable charges itself through the USB port 753.

Each Portable device based on its natural use has a smart power saving mode algorithm:
1) For a mobile phone, as FIG. 3, the Portable RF circuit can be in power-saving mode constantly and only wakes up and increases its communication frequency with the Master when it is away more than the normal distance, changes from moving status to stationary, changes from normal moving to violent moving, or any combinations thereof.
2) For a watch FIG. 4, the Portable RF circuit can be in power-saving mode constantly and only wakes up and increases its communication frequency with the Master when its temperature changes apart from the normal wearing value, changes from moving status to stationary, changes from normal moving to violent moving, or any combinations thereof.
3) For a briefcase in FIG. 5, the Portable RF circuit can be in power-saving mode constantly and only wakes up and increases its communication frequency with the Master when it changes from moving status to stationary, when it moves from normal moving to violent moving, or any combinations thereof
4) Lastly for a laptop like FIG. 6, the Portable RF circuit can be in power-saving mode constantly and only wakes up and increases its communication frequency with the Master when it senses the laptop in not in active use anymore, changes from stationary status to moving, changes from normal moving to violent moving, or any combination thereof.

The Portable device could in the future be an integrated part of the personal items and may come pre-embedded into the protected device at the manufacturing facility.

Each Portable device has a special means to generate it is own digital ID security number which makes it unique when it is added to the existing family of Portable devices with the same Master device. Once created and learned by the Master, the Portable become a family member.

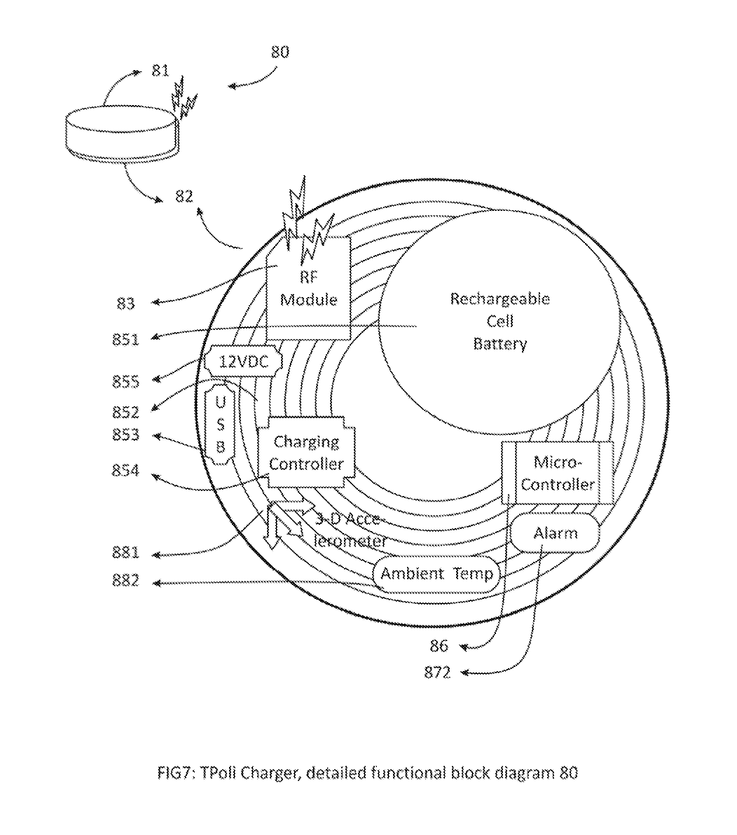

The Master operates on a rechargeable battery which is charged by contactless inductive electromagnetic waves, simply by placing it on the Charger bed. FIG. 7 is the detailed functional block diagram of the Charger. The Charger (TPoli Charger) 80 shown here is basically cradle device 82 with a flat surface bed 81 and placed on the table or counter top. The TPoli Charger is a fully integrated charging device which is powered from a 12 VDC adapter or a standard micro USB cable. It continuously creates an electromagnetic field which energizes the charging coil of any TPoli Portable devices placed on the top of it. This is a contactless approach for charging for additional convenience, where Portable items are placed on the top of the Charger without the use of any cable. The Charger itself is also protected since it has its own sensors just as the Portables. The personal items carrying the Portable devices are placed flat on the Charger bed 81 for contactless charging. The Portable has a coil 452, 552, 652 and once it is placed on the charger bed 81, it becomes within the electromagnetic field created the Charger coil 852 and it will start starts charging. The Charger 80 is equipped with an indicator to indicate that charging is in progress. The Charger powers from a standard 12 VDC 855 adapter plugged into a standard 110V AC receptacle, or may be powered from a standard 5V DC USB port 853. The Charger itself may also behave as a guard for any Portable device or even the master device, so that if the device is removed from the Charger bed, it sets off an alarm.

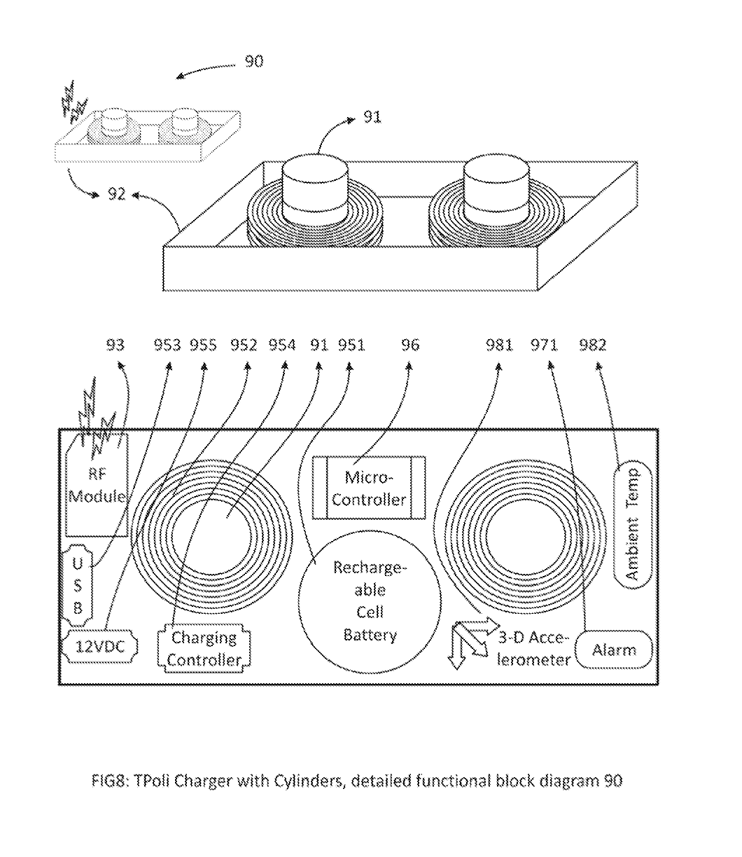

FIG. 8 depicts the alternate design for the TPoli Charger with Cylinders, as a detailed functional block diagram. The Charger (TPoli Charger) with Cylinders 90 is similar to the Basic Charger 80 but it has metallic cylinders 91 which help deliver the electromagnetic field with better volume to charge the Portables, which would then have cylinder holes to mate with the charger. The TPoli Charger in this design transfers actual electromagnetic waves to the Portables via metallic cylinders. These cylinders vary in height and diameter to serve different applications. In case of mobile phone sleeve they are low in height and wide in diameter. In case of a key chain dongle they are higher and slimmer. With these metallic cylinders the volume of electromagnetic waves is higher and thus the inductive charging is faster. The charger is still powered from a 12 VDC adapter or a standard micro USB cable. The personal items carrying the Portable devices are placed on the top of Charge where the cylinder mates with the hole on Portable device. The Portable has a coil around the cylinder hole and once it is placed on the charger cylinder, it is energized by the electromagnetic field delivered by the cylinder. The Charger also has an indicator to indicate that charging is in progress. The Charger powers from a standard 12 VDC 955 adapter plugged into a standard 110V AC receptacle. Or, it could be powered from a standard 5V DC USB port 953. This Charger itself can also act as a guard for any Portable device, or for the master device, and may set the alarm off when the device is removed from the Charger bed.

We claim:

1) An antitheft system for protection of personal electronic devices comprising a master unit and a plurality of portable wireless communication units, the master unit and each portable unit having a wireless charger, each portable unit attached to a personal electronic device item that needs protection, the master unit constantly checking and monitoring the distance away from it of the portable wireless communication units, wherein an alarm may be triggered upon reaching of a particular condition, the master unit further comprising:
a menu which gives the user various options and settings to manage and trigger the operation of the entire antitheft system, the options and settings comprising:
whether the alarm is triggered on the master, the portables, or both;
whether the alarm will be set as an audible sound, visual cue, or vibrate alarm; and
the value for a threshold safe distance between the master and each portable device;
an LCD screen for user interface and menu;
wherein the master unit and each portable unit has a rechargeable battery which is charged by contactless inductive electromagnetic waves, simply by placing it on a bed of its wireless charger.

2) The antitheft system of claim 1, wherein the master unit and the portable units are each equipped with a wireless transceiver, wherein the wireless transceiver of the master unit constantly communicates with the wireless transceiver of each portable device wirelessly by means of wireless communication signals in order to measure the distance between the two devices.

3) The antitheft system of claim 1, wherein the options and settings of the menu further comprise the choice of whether the alarm is triggered based on the condition of a threshold safe distance between the master and each portable device, based on the condition of a transition from a stationary state to a state of movement, based on the condition of a transition from a state of movement to a state of violent movement, based on the condition of an excessive temperature, based on the condition of a low battery, or any combination of these conditions.

4) The antitheft system of claim 1, wherein the alarm is actually triggered either at the master unit or at the portable units, upon the reaching of the condition of a threshold safe distance between the master and each portable device, upon the reaching of the condition of a transition from a stationary state to a state of movement, upon the condition of a transition from a state of movement to a state of violent movement, upon the reaching of condition of an excessive temperature, upon the reaching of the condition of a low battery, or upon the reaching any combination of these conditions.

5) The antitheft system of claim 1, wherein the master unit is a stand-alone unit, in a form of a key chain fob or belt-clip attachment.

6) The antitheft system of claim 1, wherein the master unit is built-in or embedded into other devices.

7) The antitheft system of claim 2, wherein the options and settings further comprise a choice between the wireless transceiver of the master unit constantly communicating with the wireless transceiver of each portable device individually wherein each portable unit has its own unique secured digital ID, or with the wireless transceivers of all portable devices at once.

8) The antitheft system of claim 1, wherein each portable unit is inseparably integrated into each corresponding personal electronic device item that needs protection in order to avoid accidental detachment.

9) The antitheft system of claim 1, wherein each portable unit may be connected with its personal electronic device item with a connector selected from the group comprising a dongle, a sleeve, a band or a USB connection; wherein each portable unit has its own power-saving mechanism to sleep, and only awakens and increases power and frequency of communication with the master unit when it senses that its corresponding personal electronic device item is no longer in not in active use, or detects a condition for triggering an alarm.

10) The antitheft system of claim 1, wherein each wireless charger charges each corresponding unit's rechargeable battery wirelessly and inductively either as a flatbed wireless charger with no connective contact or as a cylindrical charger which mates with a cylindrical hole on the unit being charged, for better delivery of the electromagnetic field with volume to charge the unit.

11) A method of preventing theft of and protecting personal electronic devices comprising the steps of:
attaching each personal electronic device item needing protection to a portable wireless communication unit having a wireless transceiver and a rechargeable battery;
deploying a master unit having a wireless transceiver, an LCD screen for user interface and a menu, and a rechargeable battery, to be in constant communication with each portable unit by means of wireless communication signals;
wherein the master and all portable units have a wireless charger to charge its rechargeable battery;
charging as needed each rechargeable battery by contactless inductive electromagnetic waves, simply by placing it on a bed of its wireless charger;
constantly checking and monitoring by the master unit of the distance away from it of each of the portable units by communication of the respective wireless transceivers;
selecting options and settings at the menu on the master unit to set the condition for triggering an alarm at the master unit or any portable unit; the options and settings comprising:
whether the alarm is triggered on the master, the portables, or both;
whether the alarm will be set as an audible sound, visual cue, or vibrate alarm; and
the value for a threshold safe distance between the master and each portable device; and
triggering the alarm upon the reaching of a certain condition.

12) The method of preventing theft of and protecting personal electronic devices of claim 11, further comprising the step of constantly communicating wirelessly by the wireless transceiver of the master unit with the wireless transceiver of each portable device by means of wireless communication signals in order to measure the distance between the two devices.

13) The method of preventing theft of and protecting personal electronic devices of claim 11, further comprising the step of selecting from the options and settings of the menu the choices of triggering the alarm based on the condition of a threshold safe distance between the master and each portable device, based on the condition of a transition from a stationary state to a state of movement, based on the condition of a transition from a state of movement to a state of violent movement, based on the condition of an excessive temperature, based on the condition of a low battery, or any combination of these conditions.

14) The method of preventing theft of and protecting personal electronic devices of claim 11, further comprising the step of actually triggering the alarm either at the master unit or at the portable units, upon the reaching of the condition of a threshold safe distance between the master and each portable device, upon the reaching of the condition of a transition from a stationary state to a state of movement, upon the condition of a transition from a state of movement to a state of violent movement, upon the reaching of condition of an excessive temperature, upon the reaching of the condition of a low battery, or upon the reaching any combination of these conditions.

15) The method of preventing theft of and protecting personal electronic devices of claim 11, wherein the step of deploying the master unit is achieved by deploying it as a stand-alone unit, in a form of a key chain fob or belt-clip attachment.

16) The method of preventing theft of and protecting personal electronic devices of claim 11, wherein the step of deploying the master unit is achieved by building it into or embedding it into other devices.

17) The method of preventing theft of and protecting personal electronic devices of claim 12, wherein the step of selecting options and settings at the menu on the master unit further comprises choosing between the wireless transceiver of the master unit constantly communicating with the wireless transceiver of each portable device individually wherein each portable unit has its own unique secured digital ID, or with the wireless transceivers of all portable devices at once.

18) The method of preventing theft of and protecting personal electronic devices of claim 11, further comprising the step of inseparably integrating each portable unit into each corresponding personal electronic device item that needs protection in order to avoid accidental detachment.

19) The method of preventing theft of and protecting personal electronic devices of claim 11, further comprising the steps of:
connecting each portable unit with its corresponding personal electronic device item using a connector selected from the group comprising a dongle, sleeve, band or USB connection;
setting each portable unit in a normal sleep mode using its own power-saving mechanism when not in active use;
awakening each portable unit from a sleep mode and increasing power and frequency of communication with the master unit when the portable unit senses that its corresponding personal electronic device item is no longer in active use, or detects a condition for triggering an alarm.

20) The method of preventing theft of and protecting personal electronic devices of claim 1 wherein the step of charging each unit's rechargeable battery with its corresponding wireless charger by contactless inductive electromagnetic waves is implemented wirelessly and inductively either as a flatbed wireless charger with no connective contact or as a cylindrical charger which mates with a cylindrical hole on the unit being charged, for better delivery of the electromagnetic field with volume to charge the unit.
